(19) United States
(12) Patent Application Publication
(10) Pub. No.: US 2003/0036998 A1
(43) Pub. Date: Feb. 20, 2003

(54) Method and system for detecting incorrect merchant code used with payment card transaction

(76) Inventor: R. Michael Alliston, Pound Ridge, NY (US)

Correspondence Address: BAKER & BOTTS, 30 ROCKEFELLER PLAZA, NEW YORK, NY, 10112

(21) Appl. No.: 10/116,870

(22) Filed: Apr. 5, 2002

Related U.S. Application Data
(60) Provisional application No. 60/281,898, filed on Apr. 5, 2001.

(51) Int. Cl. G06F 17/60

(52) U.S. Cl. 705/40

(57) ABSTRACT

There is provided a system and method for detecting incorrect merchant classification codes (“MCC's”), which includes creating a database of merchants and corresponding MCC's and establishing one or more payment card accounts. According to the method, a transaction with one of the payment card accounts is attempted with a merchant in the database. Next, the MCC transmitted in a transaction message (such as an authorization message) from the merchant is compared with the corresponding MCC for the merchant stored in the database. If the MCC's do not match, the MCC provided by the merchant is deemed incorrect and appropriate action may be taken (such as notifying the acquirer to follow up with the merchant).

### SPECIFICATION

### PRIORITY APPLICATION

This application claims priority to United States provisional application 60/281,898 filed on Apr. 5, 2001, and entitled “Method and System for Detecting Incorrect Merchant Code Used With Payment Card Transaction,” which is hereby incorporated by reference.

### BACKGROUND

In today's marketplace, payment cards - such as credit and debit cards—are ubiquitous methods of payment. These payment cards are issued either by individual card companies or by financial institutions that are members of a payment association (such as MasterCard(& International Incorporated). As used in this application, the term “payment card” includes not only physical payment cards in which the payment account information is stored on a physical card, but also virtual payment cards in which the payment account information is stored in digital or electronic form. In electronic commerce on the Internet, payment cards have become a preferred method of payment for most consumers.

By way of background, FIG. 1 is a functional block diagram of a conventional payment association payment card system. The cardholder 100 is issued a payment card by the card issuer 108. When the cardholder desires to purchase goods or services from a merchant 102, the cardholder 100 presents his or her payment card (either in-person or over the telephone or Internet) to the merchant 102. The merchant 102 has a relationship with an acquirer 104, which has access to a payment network 106. The acquirer is typically a financial institution or bank in which the merchant has a financial account. The card issuer 108 is also in communication with the payment network 106. When the merchant is presented with the cardholder's payment card, the merchant 102 requests authorization for the transaction from the acquirer 104. The acquirer in turn forwards the authorization request through the payment network to the card issuer. Based upon the cardholder's account status and the amount of the transaction, the card issuer authorizes or denies the authorization request. The card issuer's response is routed through the payment network and the acquirer to the merchant.

During a payment card transaction as described above, when a merchant sends a payment transaction message (such as an authorization request), the merchant includes in the message (among other items) a merchant classification code (“MCC”), which identifies the type of merchant sending the message. By way of example, an MCC might be “5967”—Inbound Telemarketing, “7995”—Betting (including Lottery tickets, Chips at Casinos, Off-Track Betting and Wagers at Race Tracks), or “5940”—Bicycle Shops Sales and Service. The MCC is used for various purposes. For example, the MCC may be used for determining “floor limits”, which are prescribed transaction amounts under which a transaction does not require authorization by the card issuing institution (the floor limit for a retail store may differ from the floor limit for a car rental). As another example, another use is in classifying transactions by circumstances that may effect the way association rules are applied in the event of fraud or customer dispute such as mail order and telephone order transactions.

A problem that is encountered in conventional payment card transactions is that some merchants, whether through negligence or through actual fraudulent intent, transmit an incorrect MCC with their payment transaction messages. Until now, such incorrect MCC's have been difficult to detect. Therefore, there exists a need for an easier method for detecting incorrect MCC's.

### SUMMARY OF THE INVENTION

The present invention provides a system and method for detecting incorrect MCC's. In the present invention, a database of merchants and corresponding MCC's is created and one or more payment card accounts is established. Then, a transaction with one of the payment card accounts is attempted with a merchant in the database. Next, the MCC in a transaction message (such as an authorization message) from the merchant is compared with the MCC for the merchant in the database. If the MCC's do not match, the MCC provided by the merchant is deemed incorrect and appropriate action may be taken (such as notifying the acquirer to follow up with the merchant).

The present invention finds particular applicability with Internet merchants. Preferably, with Internet merchants, the database is created by automatically scanning the web sites of the merchants and, from information gathered from the web sites, automatically classifying the merchants.

### BRIEF DESCRIPTION OF THE DRAWINGS

Exemplary embodiments of the present invention will now be described in detail with reference to the accompanying drawings in which:

FIG. 1 is a functional block diagram of a conventional payment association payment card system;

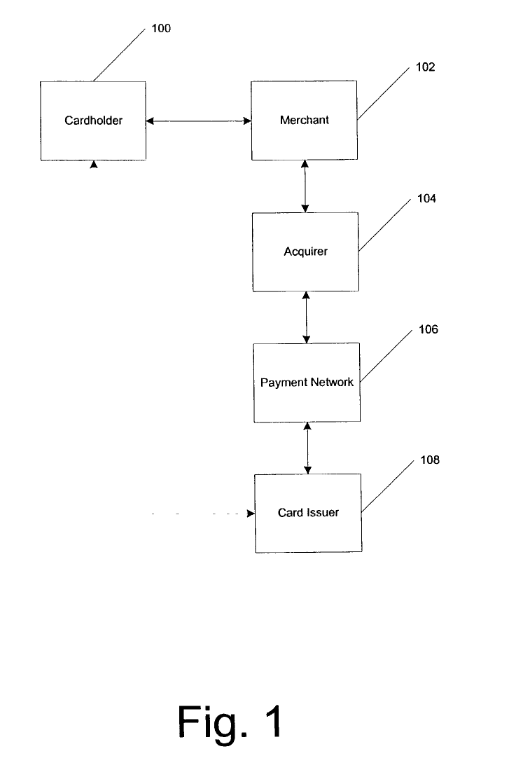

FIG. 2 is a flow chart of a method for building a database of merchants according to an exemplary embodiment of the present invention; and

FIG. 3 is a flow chart of a method for detecting an incorrect merchant code according to an exemplary embodiment of the present invention.

### DETAILED DESCRIPTION OF THE INVENTION

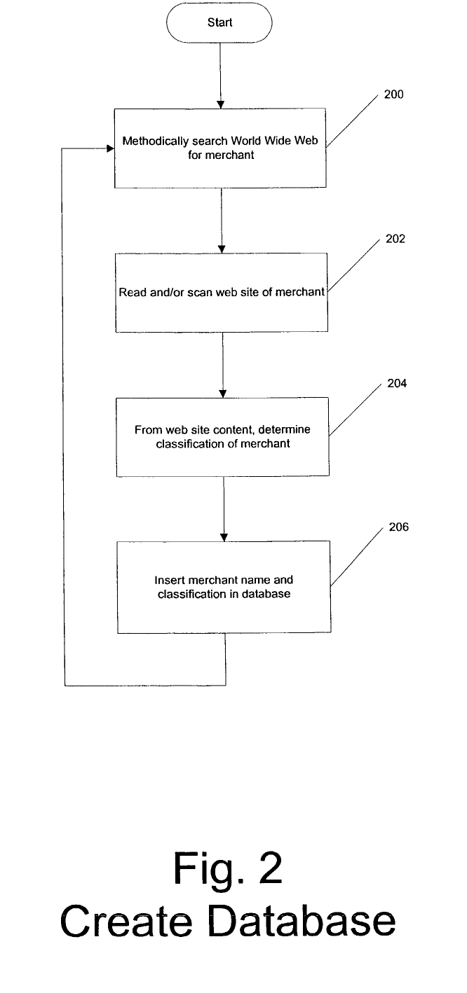

Turning to the figures, FIG. 2 is a flow chart of a method for building a database of merchants according to an exemplary embodiment of the present invention. It is assumed for the purpose of this example that the merchants are Internet merchants, although the present invention is not so limited. In step 200, the World Wide Web is methodically scanned for a merchant web site. Once a merchant web site is identified, in step 202 the merchant web is read and/or scanned. Such searching and scanning of web sites may utilize any of the methods and/or programs that are well known in the art. For example, such searching and scanning may be performed by “agents” on the world wide web which scan web sites and retrieve content (see Guttman, R., Moukas, A., and Maes, P. “Agent-mediated Electronic Commerce: A Survey”. Knowledge Engineering Review Journal, June 1998, or Maes, Pattie, Designing Autonomous Agents: Theory and Practice from Biology to Engineering and Back. Cambridge: MIT Press, March 1991, which are incorporated herein by reference in their entireties).

From the web site content read or scanned, a determination is made in step 204 of the classification the merchant. Preferably, such classification is performed automatically by a technique for classifying known in the art. For example, such classification may be performed by a variety of statistical methods such as CHAID (Chi-Square Automatic Interaction Detection), discriminate analysis, or neural networks. The first two methods are widely available and are documented in Breiman, Classification and Regression Trees, Wadsworth Press, Pacific Grove, Calif., 1984, which is incorporated herein by reference in its entirety. Neural networks are documented in Aleksander and Morton, An Introduction to Neural Computing, Chapman & Hall, New York, 1990, which is incorporated herein by reference in its entirety. Once the merchant classification is determined, in step 206 the merchant name (or other identifier) and the merchant classification code are recorded in a database. Preferably, the web address of the merchant is also recorded. The process then resumes at step 200 to locate the next merchant and determine that merchant's classification code. The process may be set to run continuously or may run periodically.

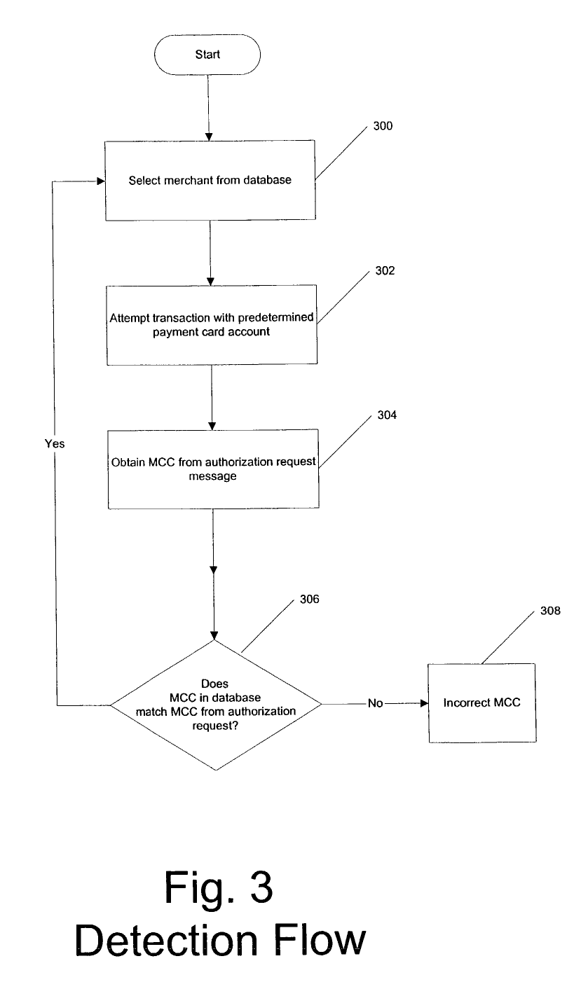

FIG. 3 is a flow chart of a method for detecting an incorrect merchant code according to an exemplary embodiment of the present invention using the database created with regard to FIG. 2. It is assumed for the purpose of this example that at least one test payment card account has been established, which shall be used for the purpose of detecting whether a merchant transmits an incorrect MCC during a transaction. Preferably, the test payment card account has a zero credit limit (if a credit card account) or a zero balance (if a debit or prepaid card account), so that any purchases attempted with the test payment card account will result in a denial of authorization. Of course, more than one test payment card account may be established for use with the method of the present invention. In addition, it is preferred that the test payment card accounts are changed periodically to avoid evasion of detection by merchants.

In step 300, a merchant is selected from the database created with regard to FIG. 2. In step 302, a transaction is attempted at the merchant's web site with the test payment card account—i.e., goods or services are attempted to be bought using the test payment card account. The merchant will likely request an authorization for the transaction amount. In the authorization request message, the merchant will transmit its MCC. This transaction message, along with the MCC, will be stored by the payment network through which the authorization request is processed. In step 304, the MCC is obtained from the transaction message processed by the payment network. In step 306, it is determined whether the MCC from the transaction message matches the MCC stored in the database. If it does match, the MCC transmitted by the merchant is deemed correct, and the process may resume at step 300 with another merchant. If the MCC's do not match, the MCC transmitted by the merchant is deemed incorrect and, in step 308, an appropriate action may be taken. For example, the merchant's acquirer may be notified and asked to follow up with the merchant. If more than one instance of incorrect MCC transmission is detected, stronger action may be taken against a merchant.

As described above, the present invention advantageously allows for the detection of incorrect MCC's transmitted by merchants.

Although preferred embodiments of the invention have been disclosed for illustrative purposes, those skilled in the art will appreciate that many additions, modifications, and substitutions are possible without departing from the true scope and spirit of the invention as defined by the accompanying claims.

I claim:

1. In a payment system wherein at least certain transaction messages include merchant classification codes, a method of detecting an incorrect merchant classification code transmitted by a merchant, comprising:
a. determining a merchant classification code for the merchant;
b. attempting to conduct, or actually conducting, a transaction with the merchant using a payment card account for which the merchant sends a transaction message with a merchant classification code through the payment system; and
c. comparing the merchant classification code transmitted by the merchant in step b with the merchant classification code determined in step a.

2. The method of claim 1, in which the step of determining a merchant classification code comprises:
a. gathering information from a web site of the merchant; and
b. based on the gathered information, determining a merchant classification code for the merchant.

3. The method of claim 1, in which the transaction message sent by the merchant is an authorization request message.

4. In a payment system wherein at least certain transaction messages include merchant classification codes, a method of detecting an incorrect merchant classification code transmitted by a merchant, comprising:
a. creating a database of merchants and corresponding merchant classification codes;
b. selecting a merchant from the database of merchants;
c. attempting to conduct, or actually conducting, a transaction with the selected merchant using a payment card account for which the merchant sends a transaction message with a merchant classification code through the payment system; and
d. comparing the merchant classification code transmitted by the merchant in step c with the merchant classification code corresponding to the merchant in the database.

5. The method of claim 4, in which the step of creating a database comprises:
a. gathering information from a web site of the merchant; and
b. based on the gathered information, determining a merchant classification code for the merchant; and
c. storing the determined merchant classification code in said database.

6. The method of claim 5, further comprising repeating steps a-c for a predetermined number of merchants.

7. The method of claim 5, further comprising repeating steps a-c for a predetermined time period.

8. The method of claim 4, in which the transaction message sent by the merchant is an authorization request message.

9. A system for detecting an incorrect merchant code forwarded in an authorization request message, sent by a particular merchant having a website and engaged in a business, through a payment system to obtain authorization for conducting a financial transaction comprising:
a. a database of a plurality of such merchants, said database having stored therein corresponding merchant classification codes, said codes being assigned automatically as a function of each of said merchant's business, said business determined by accessing said merchant's website;
b. detection means, linked to said database, for detecting whether said particular merchant has forwarded in said authorization request an incorrect merchant code by comparing the code forwarded with said authorization request with the merchant classification code corresponding to that merchant stored in the database.

10. The system of claim 9, wherein said financial transaction is conducted using a test payment card account.
